(19) United States
(12) Patent Application Publication
(10) Pub. No.: US 2020/0325816 A1
(43) Pub. Date: Oct. 15, 2020

(54) INTERNAL COMBUSTION ENGINE EXHAUST PIPE FLUIDIC PURGER SYSTEM

(71) Applicant: JETOPTERA, INC., Edmonds, WA (US)

(72) Inventor: Andrei Evulet, Edmonds, WA (US)

(21) Appl. No.: 16/685,551

(22) Filed: Nov. 15, 2019

Related U.S. Application Data
(63) Continuation of application No. 15/670,943, filed on Aug. 7, 2017, now abandoned.
Application No. 15/670,943 is a continuation-in-part of application No. PCT/US16/64827, filed on Dec. 2, 2016.
Application No. 15/670,943 is a continuation-in-part of application No. 15/456,450, filed on Mar. 10, 2017, now Pat. No. 10,464,668.
Application No. 15/456,450 is a continuation-in-part of application No. 15/256,178, filed on Sep. 2, 2016, now Pat. No. 10,207,812.
Application No. 15/670,943 is a continuation of application No. PCT/US17/21975, filed on Mar. 10, 2017.
Application No. 15/670,943 is a continuation-in-part of application No. 15/221,389, filed on Jul. 27, 2016, now Pat. No. 10,501,197.
Application No. 15/670,943 is a continuation-in-part of application No. PCT/US16/44327, filed on Jul. 27, 2016.
Application No. 15/670,943 is a continuation-in-part of application No. 15/625,907, filed on Jun. 16, 2017, now abandoned.
Application No. 15/625,907 is a continuation-in-part of application No. 15/221,389, filed on Jul. 27, 2016, now Pat. No. 10,501,197.
Application No. 15/670,943 is a continuation-in-part of application No. 15/221,439, filed on Jul. 27, 2016.
Application No. 15/670,943 is a continuation-in-part of application No. PCT/US16/44326, filed on Jul. 27, 2016.
Application No. 15/670,943 is a continuation-in-part of application No. 15/256,178, filed on Sep. 2, 2016, now Pat. No. 10,207,812.
Application No. 15/670,943 is a continuation-in-part of application No. PCT/US16/50236, filed on Sep. 2, 2016.
(60) Provisional application No. 62/371,612, filed on Aug. 5, 2016.
(60) Provisional application No. 62/371,926, filed on Aug. 8, 2016.
(60) Provisional application No. 62/379,711, filed on Aug. 25, 2016.
(60) Provisional application No. 62/380,108, filed on Aug. 26, 2016.
(60) Provisional application No. 62/525,592, filed on Jun. 27, 2017.
(60) Provisional application No. 62/531,817, filed on Jul. 12, 2017.
(60) Provisional application No. 62/263,407, filed on Dec. 4, 2015.
(60) Provisional application No. 62/307,318, filed on Mar. 11, 2016.
(60) Provisional application No. 62/307,318, filed on Mar. 11, 2016.
(60) Provisional application No. 62/213,465, filed on Sep. 2, 2015.
(60) Provisional application No. 62/213,465, filed on Sep. 2, 2015.
(60) Provisional application No. 62/213,465, filed on Sep. 2, 2015.
(60) Provisional application No. 62/213,465, filed on Sep. 2, 2015.
(60) Provisional application No. 62/213,465, filed on Sep. 2, 2015.
(60) Provisional application No. 62/213,465, filed on Sep. 2, 2015.
(60) Provisional application No. 62/213,465, filed on Sep. 2, 2015.

(51) Int. Cl. F02B 27/06; F02B 39/04; F02B 37/00; F02C 7/143; F23L 17/16; F02C 6/12; F02C 3/04; F02C 7/10

(52) U.S. Cl. CPC F02B 27/06; F02B 39/04; F02B 37/00; F02C 7/143; F23L 17/16; F05D 2260/4023; F02C 3/04; F02C 7/10; F05D 2300/6033; Y02T 10/146; Y02T 10/144; F02C 6/12

(57) ABSTRACT

An internal combustion engine includes an exhaust conduit having an exhaust port fluidically coupled to ambient fluid and having an internal cross-sectional area and an engine cylinder fluidically coupled to the exhaust conduit. A fluidic amplifier is disposed within the exhaust conduit and is fluidically coupled to the engine cylinder. The amplifier is further fluidically coupled to a source of primary fluid and is configured to introduce the primary fluid and at least a portion of fluid from the engine cylinder to the exhaust port.

### PRIORITY CLAIM

This Application is a continuation of U.S. application Ser. No. 15/670,943 filed Aug. 7, 2017; which claims the benefit of U.S. Provisional Application No. 62/371,612 filed Aug. 5, 2016; 62/371,926 filed Aug. 8, 2016; 62/379,711 filed Aug. 25, 2016; 62/380,108 filed Aug. 26, 2016; 62/525,592 filed Jun. 27, 2017; and 62/531,817 filed Jul. 12 2017.

This Application is a continuation-in-part of U.S. Ser. No. 16/656,529 filed Oct. 17,2019; which is a continuation of U.S. application Ser. No. 15/368,428 filed Dec. 2, 2016; which claims the benefit of Application No. 62/263,407 filed Dec. 4, 2015.

U.S. application Ser. No. 15/670,943 filed Aug. 7, 2017 is also a continuation-in-part of Application No. PCT/US16/64827 filed Dec. 2, 2016; which claims the benefit of Application No. 62/263,407 filed Dec. 4, 2015.

U.S. application Ser. No. 15/670,943 filed Aug. 7, 2017 is also a continuation-in-part of application Ser. No. 15/456,450 filed Mar. 10, 2017; which claims the benefit of Application No. 62/307,318 filed Mar. 11, 2016; and is a continuation-in-part of application Ser. No. 15/256,178 filed Sep. 2, 2016; which claims the benefit of Application No. 62/213,465 filed Sep. 2, 2015.

U.S. application Ser. No. 15/670,943 filed Aug. 7, 2017 is also a continuation-in-part of Application No. PCT/US17/21975 filed Mar. 10, 2017; which claims the benefit of 62/307,318 filed Mar. 11, 2016.

U.S. application Ser. No. 15/670,943 filed Aug. 7, 2017 is also a continuation-in-part of application Ser. No. 15/221,389 filed Jul. 27, 2016; which claims the benefit of Application No. 62/213,465 filed Sep. 2, 2015

U.S. application Ser. No. 15/670,943 filed Aug. 7, 2017 is also a continuation-in-part of Application No. PCT/US16/44327 filed Jul. 27, 2016; which claims the benefit of Application No. 62/213,465 filed Sep. 2, 2015.

U.S. application Ser. No. 15/670,943 filed Aug. 7, 2017 is also a continuation-in-part of application Ser. No. 15/625,907 filed Jun. 16, 2017; which is a continuation-in-part of application Ser. No. 15/221,389 filed Jul. 27, 2016; which claims the benefit of 62/213,465 filed Sep. 2, 2015.

U.S. application Ser. No. 15/670,943 filed Aug. 7, 2017 is also a continuation-in-part of application Ser. No. 15/221,439 filed Jul. 27, 2016; which claims the benefit of Application No. 62/213,465 filed Sep. 2, 2015.

U.S. application Ser. No. 15/670,943 filed Aug. 7, 2017 is also a continuation-in-part of Application No. PCT/US16/44326 filed Jul. 27, 2016; which claims the benefit of Application No. 62/213,465 filed Sep. 2, 2015

U.S. application Ser. No. 15/670,943 filed Aug. 7, 2017 is also a continuation-in-part of application Ser. No. 15/256,178 filed Sep. 2, 2016; which claims the benefit of Application No. 62/213,465 filed Sep. 2, 2015.

U.S. application Ser. No. 15/670,943 filed Aug. 7, 2017 is also a continuation-in-part of Application No. PCT/US16/50236 filed Sep. 2, 2016; which claims the benefit of Application No. 62/213,465 filed Sep. 2, 2015.

All of the aforementioned applications are hereby incorporated by reference as if fully set forth herein.

### COPYRIGHT NOTICE

This disclosure is protected under United States and/or International Copyright Laws. © 2017-2019 Jetoptera. All Rights Reserved. A portion of the disclosure of this patent document contains material that is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND

Combustion in a duct involves complex chemical, fluid-dynamic and thermal processes involving a fuel as well as an oxidizer in a confined geometry and a temperature that favors the ignition, flame propagation and stabilization of the reactive flow. The combustion process also generates a certain pressure drop, generating discontinuities in the process. This is particularly evident in race cars, where flames as much as one foot in length coming out from the exhaust pipe can be observed at times. A resulting loss in power of the race car is correlated to this flame emerging from the exhaust pipe.

An internal combustion engine (ICE) is often compared to an air pump. Horsepower increases with the amount of flow of air circulated through the engine system. Conversely, any backpressure formed in the exhaust system requires horsepower to overcome it, eroding the performance of the engine itself. Particularly in racing cars, one can obtain an increase in the horsepower if efficient increase of intake of air and efficient purging of gas from the engine is achieved, minimizing the horsepower spent on reducing pumping losses through the exhaust pipe. For a given engine volume, the more air supplied to it means the more power is extracted, and its efficiency is increased. In addition, the more streamlined the exhaust gas flow is, the less power is expended on pushing the exhaust gas out, hence increasing the power available to the propulsion.

A high-performance racing car typically uses an ICE. The mixture of the fuel and air is tuned to produce the maximum power at most times, but in less ideal conditions (e.g., turning curves, etc.), the stoichiometry is somewhat changed, and the chemistry, local wall temperatures, and residence time in the pipe are such that they favor ignition of the combustible mixture. As such, at different moments in the race, flames appear from the exhaust pipe. Flames are a signal of inefficiencies, i.e., the fuel is not being burned in the engine and excess fuel is leaving the cylinder and entering the exhaust system.

As discussed, the flame observed is the fuel reigniting when the conditions are appropriate (stoichiometry, residence time, and temperature). The loss of efficiency, thus, comes from the fuel burning in the wrong location. Wherever a combustion or reacting flow occurs in a confined location such as a pipe, pressure losses occur and a disturbance of the flow is observed. The upstream processes of the combustion or flame front are equally impacted, with a certain pressure loss of the flow resulting from this process. Moreover, the undesired presence of the flame inside the exhaust pipe means that the upstream conditions to and including the ICE are affected negatively, including the thermal stresses, the life of the components, and the thermodynamic efficiency of the system.

It is desirable that a streamlined flow is maintained (i.e., combustible mixture pushed out of the pipe via reduction of the residence time in the hot exhaust). The less time the combustible mixture spends inside the exhaust pipe, the lower the propensity of ignition and the higher the efficiency of the entire system.

The restrictions in the exhaust system of an automobile typically include a catalytic converter, a resonator, and a muffler. Regulations require these for both emissions and noise reduction purpose. It is important to minimize the flow losses through this system and recover some of the power spent on overcoming these flow blockages.

With every opening of an exhaust valve, pressure arises in the exhaust manifold and typically the pressure drops in the exhaust manifolds between the openings of the exhaust valves of all cylinders. This problem can be exacerbated at lower rotational speeds. Interference between the exhaust flows from multiple cylinders inside the manifold may cause a decrease in horsepower. The ideal exhaust manifold/header and exhaust system would create a lower pressure zone that effectively purges the manifold downstream resulting in an increase in horsepower.

FIG. 1 illustrates the exhaust flow of a conventional ICE 101 during the exhaust stroke of a piston 110. Specifically, FIG. 1 illustrates a combustion chamber 120, an exhaust valve 130 at its open state, an exhaust pipe 140, and the exit port 150 of the exhaust pipe.

### BRIEF DESCRIPTION OF THE DRAWINGS

FIG. 1 illustrates a conventional ICE exhaust system.

FIG. 2 illustrates an embodiment of the present invention.

FIG. 3 illustrates a cross-sectional view of the upper half of a fluidic amplifier according to an embodiment of the present invention.

FIG. 4 illustrates an exhaust system with one embodiment of the present invention amplifier placed inside of an exhaust pipe.

### DETAILED DESCRIPTION OF THE PREFERRED EMBODIMENT

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Embodiments of the present invention include a modified Coanda ejector that is of non-round geometry and has a 3-D inlet section which contains a plurality of primary nozzles which introduce motive fluids as wall jets. Augmentation and 3-D inlet designs are disclosed in U.S. Provisional Patent Application 62/213,465, entitled FLUIDIC PROPULSIVE SYSTEM AND THRUST AND LIFT GENERATOR FOR UNMANNED AERIAL VEHICLES, filed Sep. 2, 2015 (“the '465 Provisional Application”). The '465 Provisional Application is herein incorporated by reference in its entirety. The 3-D geometric features and other designs disclosed in '465 Provisional Application may be applied to embodiments of the present invention, such as a symmetric or non-symmetric ejector as described and adapted to an exhaust pipe of the system.

The motive fluid may be air supplied from a compressor of a turbocharger, an electric motor driven mini-compressor, or a small portion of the pressurized exhaust gas from an ICE, routed toward the said ejector. Embodiments of the ejector may be of fixed-or variable-geometry, matching the systems conditions, and operating such that it optimizes the performance at all times. One preferable embodiment has no moving parts, and may be round or non-round in nature, with its inlet and exhaust being essentially 3-D in nature (i.e., not 2-D). This 3-D feature can enable better entrainment of the incoming flow and its acceleration towards the exit of the exhaust pipe.

Embodiments of the present invention allow for rapid evacuation of exhaust gases from a confined pipe, thereby allowing for a rapid and constant (or pulsed) evacuation of the gases and streamlining the exhaust flow. As a result, the upstream processes of the combustion zone inside the confined pipe are relieved of the reaction zone blockage, and flow is rapidly evacuated towards an exit, avoiding altogether combustion occurring inside the pipe. A streamlined flow can exist and the residence time can stay at all times below a certain level.

For a given flow of air through the system and air-to-fuel ratio, the power used to evacuate the exhaust gas is inversely proportional to horsepower available at the flywheel. Other optionally advantageous benefits include the reduction of fuel consumption and the increase in miles per gallon.

Current methods of increasing the horsepower available to the driver while reducing the exhaust flow losses include: tuned headers, dual exhaust systems, resonator removals and oversizing of the exhaust gas system. Embodiments of the present invention achieve this goal via a fluidic amplifier which may be positioned inside the exhaust manifold, exhaust pipe and/or muffler, driven by a source of high pressure such as belt driven air pump, air compressor or even exhaust gas at pressure from the cylinder. Embodiments of the invention have the optionally advantageous feature of the removal of any reacting flow such as flames causing additional blockages inside the exhaust pipe. An embodiment reduces the residence time and the local stoichiometry to prevent autoignition inside the exhaust system.

For instance, NASCAR teams will generally work with a fuel injected V-8 of 725 HP without the restrictor plates in the intake and will feed into an exhaust header and short pipes. In this example, dealing with the pressure waves in the exhaust is inevitable. A backfire at the outlet or in the pipe sends a disruptive (out-of-phase) pressure change back up the system, which interferes with cylinder scavenging and filling. NASCAR engines need to handle the upstream impact. The goal of a tuned header and exhaust system is to raise power output by optimally filling the cylinders at the intake end—i.e., pulling in more air/fuel mixture by exhausting more efficiently.

Embodiments of the present invention show improved entrainment by means of novel elements that rely on 3-D geometrical and fluid flow effects and utilization of separation avoidance techniques. The entrainment ratios of these embodiments are between 3-15, preferably higher. By entrainment ratio we refer to the ratio of the amount of mass flow rate entrained by the motive flow to the motive fluid flow rate. Generally, embodiments of the device will receive the motive gas from a pressurized source such as a source of pressurized fluid, exhaust gas or air; a piston engine (for pulsed operations) exhaust discharge; or a compressor or supercharger. Another optionally advantageous feature of the present invention is the ability to change the shape of the diffusor walls of the flat ejector utilized for entrainment by retracting and extending the surfaces to modify the geometry such that maximum performance is obtained at all points of the operation of the ICE.

In one embodiment, a fluidic amplifier is placed at a location inside the exhaust pipe, preferably in the center and without touching the walls of the exhaust pipe. A motive fluid supplied from the higher-pressure fluid source, such as a supercharger or any region of the system providing higher pressure fluid, is then introduced via an inlet pipe towards a plenum. Placing embodiments of the present invention inside the exhaust pipe and using a motive fluid at near-static pressure as compared to the flow inside the exhaust pipe can energize the local flow to a point where the pressure is dropped and the main reacting flow is quenched and accelerated out of the exhaust pipe.

In this embodiment, the device can be non-circular and with several 3-D features that, upon the introduction of the higher-pressure fluid, increase the number of multiple high-speed wall jets that follow along the contour of the walls of the device. The motive fluid thus moves the flow according to the internal walls of the device into an essentially axial direction. The introduction of the motive fluid at very high velocities close to sonic velocity results in a local static pressure drop according to the Bernoulli principle. In response, a large area of lower pressure forms around the 3D features of the inlet of the device, creating an effect of entrainment of the main exhaust gas flowing inside the exhaust pipe. The result is an acceleration of the flow to local speeds higher than 100 m/sec, with variations depending on the geometry of the device and the quality of the motive fluid. The high speed of the mixture emerging from the device reduces the residence time required for the ignition of the main exhaust gas upstream of the device, preventing ignition and blowing out any incipient flame that can form due to presence of additional oxygen and fuel in the exhaust. Hence, embodiments of the present invention allow for a slow-or non-reacting flow to freely be pushed at higher velocity outside the exhaust pipe, quenching any flame that may exist, and in addition, allow the forced exhaust to freely exit the conduit. This in turn enhances the operation of the system by avoiding any downstream flame or reacting flow-pressure changes that may otherwise impact the upstream ICE operation.

In this embodiment, the role of the Coanda ejector placed inside the exhaust pipe is to assure the lack of the presence of the flame via high speed local quenching and lowering the local static pressure according to the Bernoulli principle. This enhances the operation of the ICE such as those used in a racing car and operation without major disruptions related to a flame presence. Once the exhaust valve of an ICE opens, the heat carried by the gases is wasted and any re-ingestion into the engine is to be avoided.

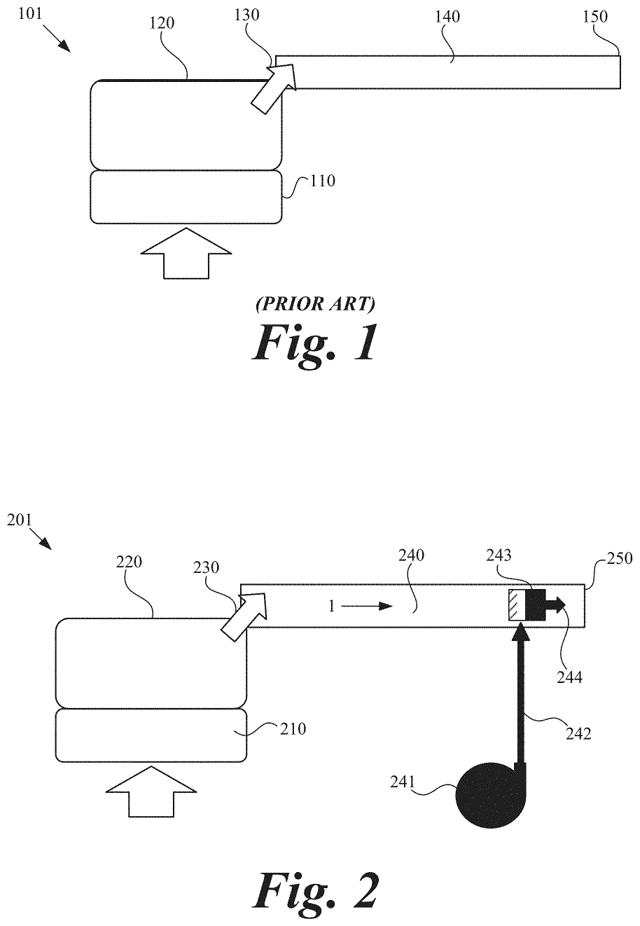

FIG. 2 illustrates an ICE 201 according to an embodiment and similar in arrangement to that shown in FIG. 1. ICE 201 includes a fluidic amplifier, such as an ejector 243, disposed downstream from an engine cylinder 220 and within a conduit, such as an exhaust pipe 240, having an internal cross-sectional area. ICE 201 further includes a fluid source 241 that delivers high-pressure air/motive fluid via a conduit 242 to the ejector 243 to produce a motive stream 244. Ejector 243 augments/accelerates the flow of exhaust gas 1 released from cylinder 220 via an exhaust valve 230. The introduction of the motive fluid into the ejector 243 can augment the flow of gas 1 by producing a significant reduction of the static pressure in front of the ejector, which allows more of the exhaust gas to be delivered from the cylinder 220 to the pipe 240 during the entire time motive fluid from source 241 is delivered to the ejector. This augmentation of the flow of gas 1 to higher velocities reduces the residence time and the stoichiometry of the fuel-air mixture in cylinder 220, which in turn reduces the likelihood of igniting the mixture before the exhaust gas leaves the exhaust port 250 of the pipe 240.

As best illustrated in FIG. 4, and in an embodiment, ejector 243 occupies less than the internal cross-sectional area of the exhaust pipe 240 such that at least a portion of gas 1 can flow around the ejector within the exhaust pipe. The source 241 may modulate the flow to create a pulsed operation of the ejector 243 such that the motive stream 244 flow is enhanced and/or produced only at the time that the valve 230 is open or other predetermined frequency. In other embodiments, the operation can be continuous and not pulsed. The source 241 of compressed fluid/air may be a compressor, mechanically and/or electrically driven. The source 241 may also be any other stored or generated high-pressure source within the system. The engine is fine-tuned by finding the appropriate operation of the ejector.

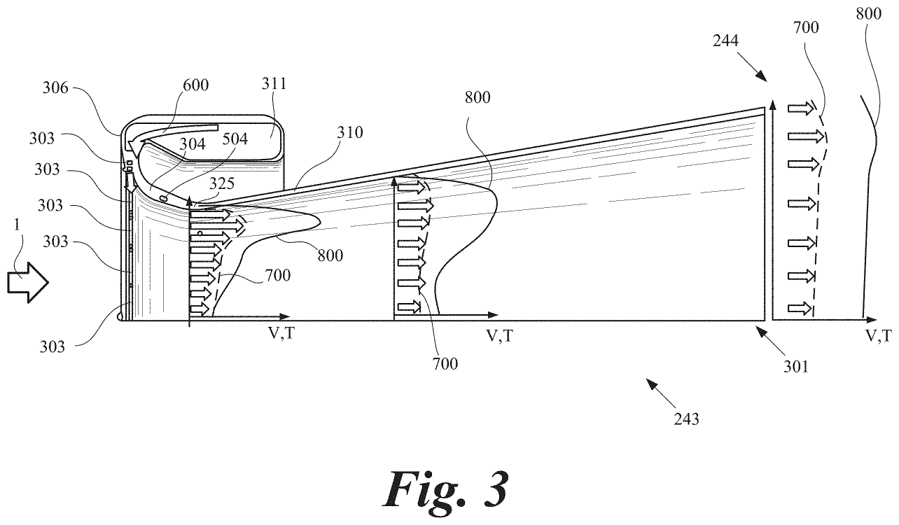

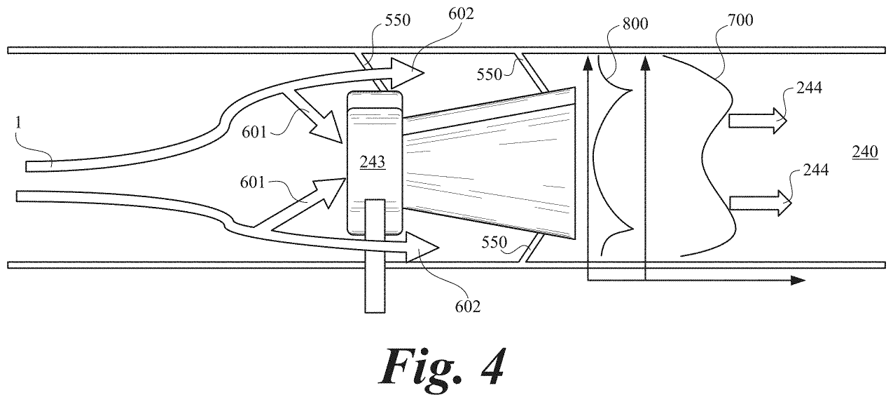

In the embodiment illustrated in FIG. 3, only the upper half of the ejector 243 is shown in cross-sectional view. The fluid flow illustrated in FIG. 3 and discussed below herein is from left to right. A plenum 311 is supplied with hotter-than-ambient air (i.e., a pressurized motive gas stream) from, for example, a combustion-based engine. This pressurized motive gas stream, denoted by arrow 600, is introduced via at least one conduit, such as primary nozzles 303, to the interior of the ejector 243. More specifically, the primary nozzles 303 are configured to accelerate the motive fluid stream 600 to a variable predetermined desired velocity directly over a convex Coanda surface 304 as a wall jet. Coanda surface 304 may have one or more recesses 504 formed therein. Additionally, primary nozzles 303 provide adjustable volumes of fluid stream 600. This wall jet, in turn, serves to entrain through an intake structure 306 secondary fluid, such as exhaust gas, denoted by arrow 1, from cylinder 220 that may be at rest or approaching the ejector 243 at non-zero speed from the direction indicated by arrow 1. In various embodiments, the nozzles 303 may be arranged in an array and in a curved orientation, a spiraled orientation, and/or a zigzagged orientation.

The mix of the stream 600 and the gas 1 may be moving purely axially at a throat section 325 of the ejector 243. Through diffusion in a diffusing structure, such as diffuser 310, the mixing and smoothing out process continues so the profiles of temperature 800 and velocity 700 in the axial direction of ejector 243 no longer have the high and low values present at the throat section 325, but become more uniform at the terminal end 100 of diffuser 310. As the mixture of the stream 600 and the gas 1 approaches the exit plane of terminal end 301, the temperature and velocity profiles are almost uniform. In particular, the temperature of the mixture is low enough to prevent auto-ignition of any fuel remaining inside the exhaust pipe, and the velocity is high enough to reduce the residence time in the hot walls zone.

FIG. 4 shows an embodiment of the present invention ejector 243 placed inside of exhaust pipe 240. In accordance with the embodiment illustrated in FIG. 4, the local exit flow of stream 244 is at higher speed than the velocity of the incoming gas 1 absent the presence of ejector 243. This is due to the majority of the gas 1 coming from the cylinder 220 being entrained into the ejector 243 at high velocity, as indicated by arrows 601, due to the lowering of the local static pressure in front of the ejector 243. As indicated by arrows 602, a smaller portion of gas 1 bypasses and flows around the ejector 243 and over the mechanical supports 550 that position the ejector in the center of the pipe 240. The ejector 243 vigorously mixes a hotter motive stream provided by the air/gas source 241 (e.g., a compressor) with the incoming gas 1 stream at high entrainment rate. The mixture is homogeneous enough to increase the temperature of the motive stream 600 of the ejector to a mixture temperature profile 700 that can quench any potential flame of the incoming flammable exhaust gas 1. The velocity profile of the efflux jet 800 leaving the ejector 243 is such that it reduces the residence time in the downstream portion of the exhaust pipe 240, and further reduces the propensity of a flame, as well as streamlining the purging of the flow.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

We claim:

1. An internal combustion engine, comprising:
an exhaust conduit having an exhaust port fluidically coupled to ambient fluid, the exhaust conduit having an internal cross-sectional area;
an engine cylinder fluidically coupled to the exhaust conduit; and
a fluidic amplifier disposed within the exhaust conduit, the amplifier fluidically coupled to the engine cylinder, the amplifier further fluidically coupled to a source of primary fluid, the amplifier configured to introduce the primary fluid and at least a portion of fluid from the engine cylinder to the exhaust port.

2. The engine of claim 1, wherein the amplifier occupies less than the internal cross-sectional area of the exhaust conduit.

3. The engine of claim 1, wherein the amplifier comprises:
a convex surface;
a diffusing structure coupled to the convex surface; and
an intake structure coupled to the convex surface and configured to introduce to the diffusing structure the primary fluid, wherein the diffusing structure comprises a terminal end configured to provide egress from the amplifier for the introduced primary fluid and fluid from the engine cylinder.

4. The engine of claim 3, wherein the convex surface includes a plurality of recesses.

5. The engine of claim 1, wherein the amplifier is configured to introduce the primary fluid in a pulsed manner at a predetermined frequency.

6. The engine of claim 1, wherein the primary fluid source comprises at least one of a mechanically or turbine-driven compressor.

7. A method of enhancing the performance of an internal combustion engine, the engine having an exhaust conduit including an exhaust port fluidically coupled to ambient fluid and having an internal cross-sectional area, the engine further having a cylinder fluidically coupled to the exhaust conduit, the method comprising the steps of:
positioning a fluidic amplifier within the exhaust conduit, such that the amplifier is fluidically coupled to the engine cylinder; and
fluidically coupling a source of primary fluid to the amplifier, the amplifier configured to introduce the primary fluid and at least a portion of fluid from the engine cylinder to the exhaust port.

8. The method of claim 7, wherein the amplifier occupies less than the internal cross-sectional area of the intake conduit.

9. The method of claim 7, wherein the amplifier comprises:
a convex surface;
a diffusing structure coupled to the convex surface; and
an intake structure coupled to the convex surface and configured to introduce to the diffusing structure the primary fluid, wherein the diffusing structure comprises a terminal end configured to provide egress from the amplifier for the introduced primary fluid and fluid from the engine cylinder.

10. The method of claim 9, wherein the convex surface includes a plurality of recesses.

11. The method of claim 7, wherein the amplifier is configured to introduce the primary fluid in a pulsed manner at a predetermined frequency.

12. The method of claim 7, wherein the primary fluid source comprises at least one of a mechanically or turbine-driven compressor.

13. A vehicle, comprising:
an exhaust conduit having an exhaust port fluidically coupled to ambient fluid, the exhaust conduit having an internal cross-sectional area;
an engine chamber fluidically coupled to the exhaust conduit; and
a fluidic amplifier disposed within the exhaust conduit, the amplifier fluidically coupled to the engine chamber, the amplifier further fluidically coupled to a source of primary fluid, the amplifier configured to introduce the primary fluid and at least a portion of fluid from the engine chamber to the exhaust port.

14. The vehicle of claim 13, wherein the amplifier occupies less than the internal cross-sectional area of the exhaust conduit.

15. The vehicle of claim 13, wherein the amplifier comprises:
a convex surface;
a diffusing structure coupled to the convex surface; and
an intake structure coupled to the convex surface and configured to introduce to the diffusing structure the primary fluid, wherein the diffusing structure comprises a terminal end configured to provide egress from the amplifier for the introduced primary fluid and fluid from the engine chamber.

16. The vehicle of claim 15, wherein the convex surface includes a plurality of recesses.

17. The vehicle of claim 13, wherein the amplifier is configured to introduce the primary fluid in a pulsed manner at a predetermined frequency.

18. The vehicle of claim 13, wherein the primary fluid source comprises at least one of a mechanically or turbine-driven compressor.
